(19) United States
(12) Patent Application Publication
(10) Pub. No.: US 2020/0368833 A1
(43) Pub. Date: Nov. 26, 2020

(54) RECIPROCATING SAW

(71) Applicant: TECHTRONIC CORDLESS GP, Anderson, SC (US)

(72) Inventors: Curt A. Laugh, Anderson, SC (US); C. Eric Lagman, Anderson, SC (US); Ming Qiang, Dongguan (CN); Brent N. Gregorich, Easley, SC (US)

(21) Appl. No.: 16/959,741

(22) PCT Filed: Jan. 4, 2019
(86) PCT No.: PCT/CN2019/070470

§ 371 Date: Jul. 2, 2020

Related U.S. Application Data
(60) Provisional application No. 62/613,930, filed on Jan. 5, 2018.

(51) Int. Cl. B23D 51/16; B23D 49/16

(52) U.S. Cl. CPC B23D 51/16; B23D 51/01; B23D 49/167; B23D 49/165

(57) ABSTRACT

A reciprocating saw includes a housing including a handle defining a handle axis extending centrally through the handle from a first end to a second end of the handle, a battery receptacle located adjacent the second end of the handle, a battery insertable into and removable from the battery receptacle along a battery axis, a motor powered by the battery and including a motor shaft rotatable about a motor axis, and a spindle configured to reciprocate along a spindle axis in response to rotation of the motor shaft. The spindle axis is parallel to the motor axis.

### CROSS-REFERENCE TO RELATED APPLICATIONS

This application is a national phase filing under 35 U.S.C. § 371 of International Application No. PCT/CN2019/070470 filed Jan. 4, 2019, which claims priority to U.S. Provisional Patent Application No. 62/613,930 filed on Jan. 5, 2018, the entire content of which is incorporated herein by reference.

### FIELD OF THE INVENTION

The present invention relates to reciprocating saws.

### BACKGROUND

Reciprocating saws are used to cut a variety of different objects and materials. Typical reciprocating saws, however, are relatively long and configured for two-handed operation. Such reciprocating saws may be difficult to use in tight spaces and awkward angles commonly encountered in plumbing, HVAC, and electrical applications.

### SUMMARY

The invention provides, in one aspect, a reciprocating saw including a housing with a handle defining a handle axis extending centrally through the handle from a first end to a second end of the handle, a battery receptacle located adjacent the second end of the handle, a battery insertable into and removable from the battery receptacle along a battery axis, a motor powered by the battery and including a motor shaft rotatable about a motor axis, and a spindle configured to reciprocate along a spindle axis in response to rotation of the motor shaft. The spindle axis is parallel to the motor axis.

In some embodiments, the battery axis is oriented relative to the handle axis at an angle between 75 and 95 degrees.

In some embodiments, the battery axis is perpendicular to the handle axis.

In some embodiments, the motor is located adjacent the first end of the handle.

In some embodiments, the reciprocating saw includes a drive gear coupled to the motor shaft for rotation about the motor axis, a driven gear meshed with the drive gear, and a drive shaft coupled for co-rotation with the driven gear about a drive shaft axis. In some embodiments, the drive shaft axis is perpendicular to the motor axis.

In some embodiments, the reciprocating saw includes an orbital motion assembly configured to selectively impart a pivoting motion to the spindle in response to rotation of the drive shaft.

In some embodiments, the orbital motion assembly includes an actuator movable between an engaged position and a disengaged position, a spindle carrier pivotally coupled to the housing and supporting the spindle such that the spindle carrier and the spindle are pivotable together relative to the housing about a pivot axis, a strike plate coupled to the drive shaft, the strike plate configured to reciprocate in response to rotation of the drive shaft, and a roller coupled to the spindle carrier. In some embodiments, the strike plate is engageable with the roller as the strike plate reciprocates to cause the spindle carrier and the spindle to pivot back and forth about the pivot axis when the actuator is in the engaged position. In some embodiments, the roller is prevented from engaging the strike plate when the actuator is in the disengaged position.

In some embodiments, the motor axis is oriented relative to the handle axis at an angle between 5 and 45 degrees.

The invention provides, in another aspect, a reciprocating saw including a housing with a handle defining a handle axis extending centrally through the handle from a first end to a second end of the handle, a battery receptacle located adjacent the second end of the handle, a battery insertable into and removable from the battery receptacle along a battery axis, a motor powered by the battery and including a motor shaft rotatable about a motor axis, and a spindle configured to reciprocate along a spindle axis in response to rotation of the motor shaft. The handle axis is perpendicular to the battery axis. The motor axis is oriented relative to the handle axis at an angle between 5 and 45 degrees.

In some embodiments, the spindle axis is oriented relative to the handle axis at an angle between 5 and 45 degrees.

In some embodiments, the spindle axis is parallel to the motor axis.

In some embodiments, the reciprocating saw includes an orbital motion assembly configured to selectively impart a pivoting motion to the spindle. The orbital motion assembly includes a spindle carrier pivotally coupled to the housing and supporting the spindle such that the spindle carrier and the spindle are pivotable together relative to the housing about a pivot axis, a strike plate configured to reciprocate in a direction parallel to the motor axis, and a roller coupled to the spindle carrier. In some embodiments, the strike plate is engageable with the roller as the strike plate reciprocates to cause the spindle carrier and the spindle to pivot back and forth about the pivot axis when the reciprocating saw is operated in an orbiting mode, and in some embodiments, the roller is prevented from engaging the strike plate when the reciprocating saw is operated in a non-orbiting mode.

In some embodiments, the motor is located adjacent the first end of the handle.

In some embodiments, the reciprocating saw includes a drive gear coupled to the motor shaft for rotation about the motor axis, a driven gear meshed with the drive gear, a drive shaft coupled for co-rotation with the driven gear about a drive shaft axis, and a scotch yoke mechanism coupling the drive shaft to the spindle. In some embodiments, the drive shaft axis is perpendicular to the motor axis.

The invention provides, in another aspect, a reciprocating saw including a housing with a handle defining a handle axis extending centrally through the handle from a first end to a second end of the handle, a battery receptacle located adjacent the second end of the handle, a battery insertable into and removable from the battery receptacle along a battery axis, a motor powered by the battery and including a motor shaft rotatable about a motor axis, the motor located adjacent the first end of the handle, and a spindle configured to reciprocate along a spindle axis in response to rotation of the motor shaft. The spindle axis is oriented relative to the handle axis at an angle between 5 and 45 degrees.

In some embodiments, the reciprocating saw includes an orbital motion assembly including an actuator movable between an engaged position and a disengaged position, and the orbital motion assembly is configured to impart a pivoting motion to the spindle when the actuator is in the engaged position.

In some embodiments, the motor axis is parallel to the spindle axis.

In some embodiments, the battery axis is oriented relative to the handle axis at an angle between 75 and 95 degrees.

In some embodiments, the reciprocating saw includes a drive gear coupled to the motor shaft for rotation about the motor axis, a driven gear meshed with the drive gear, and a drive shaft coupled for co-rotation with the driven gear about a drive shaft axis. In some embodiments, the drive shaft axis is perpendicular to the motor axis.

In some embodiments, the reciprocating saw includes a trigger positioned on the handle adjacent the first end.

Other features and aspects of the invention will become apparent by consideration of the following detailed description and accompanying drawings.

### BRIEF DESCRIPTION OF THE DRAWINGS

FIG. 1 is a perspective view of a reciprocating saw according to one embodiment.

FIG. 2 is a side view of the reciprocating saw of FIG. 1.

FIG. 3 is a cross-sectional view of the reciprocating saw of FIG. 1.

FIG. 4 is a side view of the reciprocating saw of FIG. 1 with a housing removed.

FIG. 5 is a perspective view of a portion of the reciprocating saw of FIG. 1.

FIG. 6 is a perspective view of a portion of the reciprocating saw of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

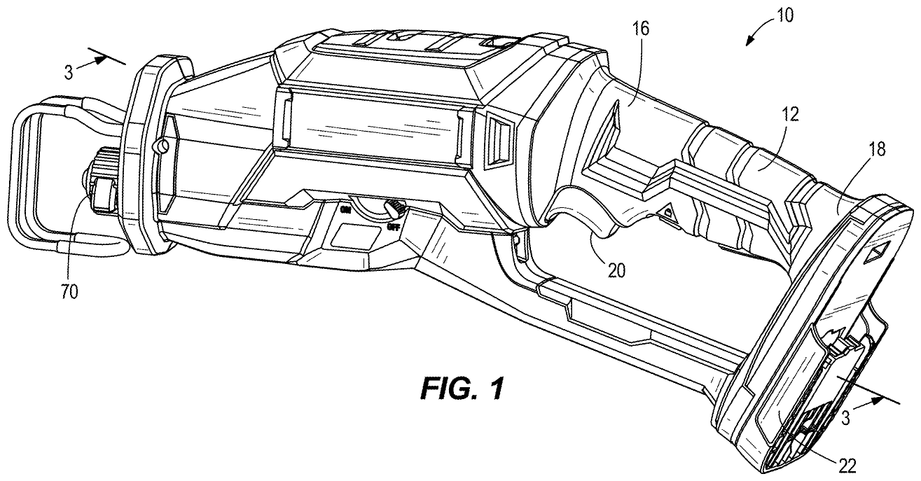

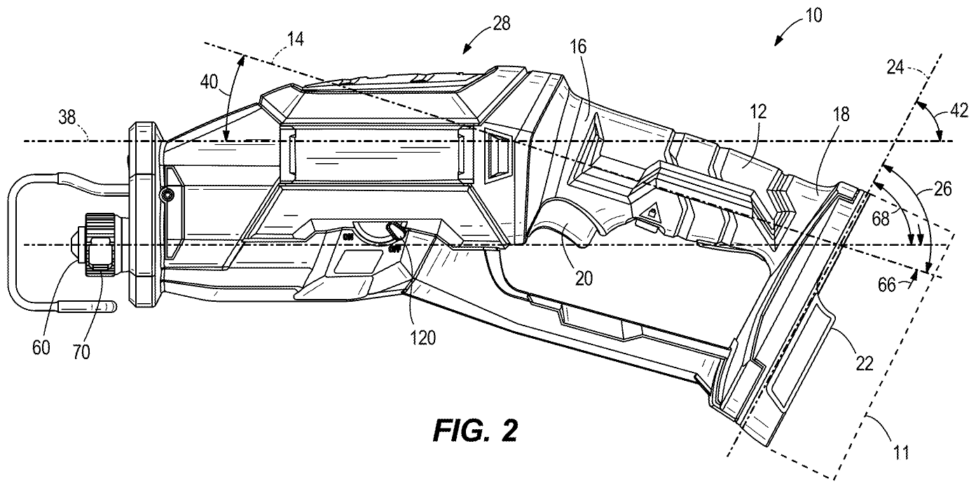

FIG. 1 illustrates a reciprocating saw 10. The illustrated saw 10 is battery powered, such as by a lithium-ion battery 11 (e.g., a 12, 18, or 24 volt battery, illustrated in broken lines in FIG. 2). The saw 10 includes a handle 12 by which the saw 10 can be gripped by a user to hold and use the saw 10. Referring to FIG. 2, the handle 12 has an axis 14. The handle axis 14 extends centrally through the handle 12. The handle 12 includes a first or front end 16 and a second or back end 18. The handle axis 14 extends through the front and back ends 16, 18 of the handle 12 as shown in FIG. 2. A trigger or switch 20 is positioned on or adjacent the handle 12 and adjacent the front end 16 of the handle 12. The switch 20 is positioned so that the user can use their index finger to actuate or squeeze the switch 20 to power the saw 10.

A battery receptacle or recess 22 is located adjacent the back end 18 of the handle 12. The battery recess 22 includes battery terminals that are coupled to the battery 11 to distribute power and control to the saw 10. The battery 11 is removably coupled to the saw 10 so that the battery 11 can be removed for charging and can be replaced with a charged battery. The battery 11 is attached to and detached from the saw 10 by sliding the battery 11 along a battery axis 24 into and out of the battery recess 22. The battery axis 24 is oriented at an angle 26 relative to the handle axis 14. In the illustrated embodiment, the angle 26 is about 90 degrees. In other embodiments, the angle 26 is between 85 degrees and 95 degrees. In other embodiments, the angle 26 is between 75 degrees and 95 degrees.

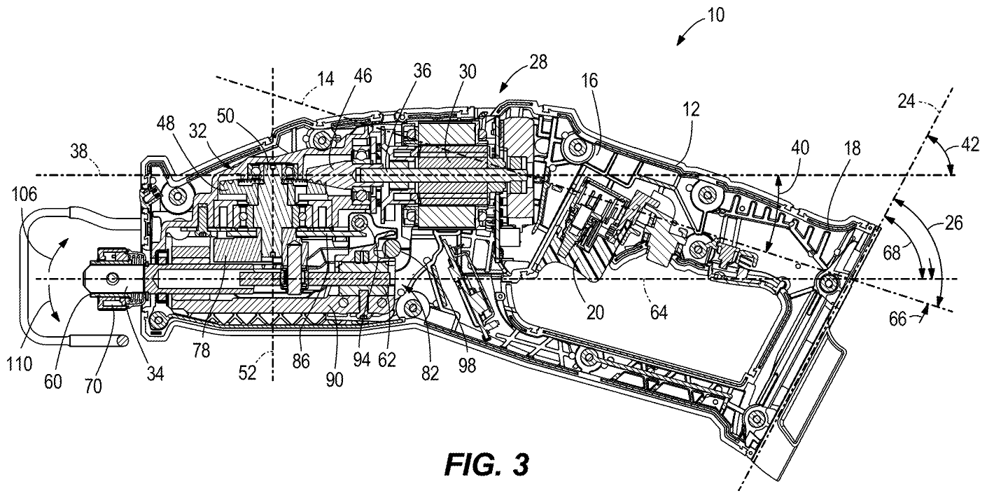

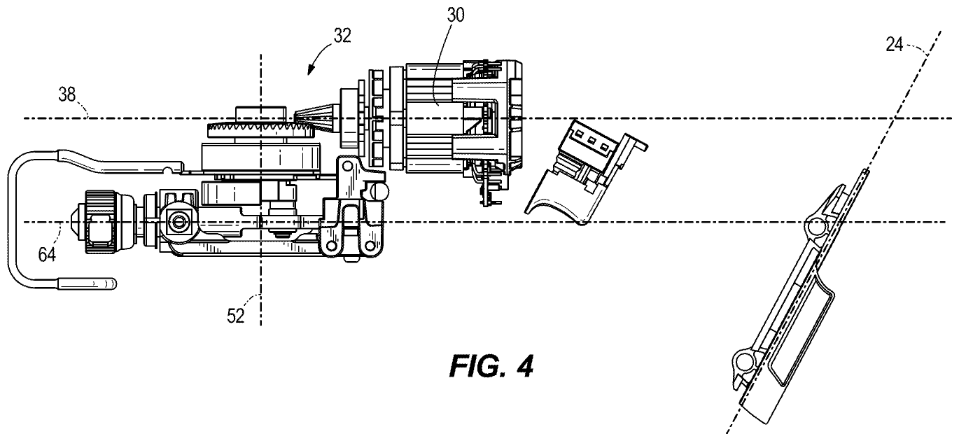

Referring to FIGS. 3 and 4, the saw 10 further includes a housing 28 that supports a motor 30, a transmission 32, and a spindle 34. The motor 30 is located adjacent the front end 16 of the handle 12, and the battery recess 22 is located adjacent the back end 18 of the handle 12. The motor 30 is powered by the battery 11 when the battery 11 is received in the battery recess 22. The motor 30 includes a shaft 36 that is rotated by power from the battery 11 when the user presses the switch 20. A motor axis 38 is defined as an axis that extends centrally through the motor shaft 36 along the length of the shaft 36, and the shaft 36 rotates about the motor axis 38.

The motor axis 38 is oriented at an angle 40 relative to the handle axis 14 as shown and measured as indicated in FIG. 3. In the illustrated embodiment, the angle 40 is about 20 degrees. In other embodiments, the angle 40 is between 15 degrees and 25 degrees. In yet other embodiments, the angle 40 is between 10 degrees and 30 degrees. In yet other embodiments, the angle 40 is between 5 degrees and 45 degrees.

The motor axis 38 is also oriented at an angle 42 relative to the battery axis 24 as shown and measured as indicated in FIG. 3. In the illustrated embodiment, the angle 42 is about 60 degrees. In other embodiments, the angle 42 is between 55 degrees and 65 degrees. In yet other embodiments, the angle 42 is between 50 degrees and 70 degrees. In yet other embodiments, the angle 42 is between 30 degrees and 80 degrees.

The transmission 32 includes drive gear 46, a driven gear 48, and a drive shaft 50. The drive gear 46 is coupled to the motor shaft 36 for rotation with the motor shaft 36. The drive gear 46 engages the driven gear 48 to rotate the driven gear 48 in response to rotation of the motor shaft 36. The driven gear 48 is coupled to the drive shaft 50 for rotation with the drive shaft 50 so that rotation of the motor shaft 36 rotates the drive shaft 50. The drive shaft 50 rotates about drive shaft axis 52. The drive shaft axis 52 is generally perpendicular to the motor axis 38.

The spindle 34 includes a first end 60 and a second end 62. A spindle axis 64 extends centrally though the spindle 34 along a length of the spindle 34 and through the ends 60, 62. The spindle 34 reciprocates along the spindle axis 64 in response to rotation of the motor shaft 36. The spindle axis 64 is parallel to the motor axis 38. As used herein, the term “parallel” excludes a coaxial relationship. The spindle axis 64 is at an angle 66 relative to the handle axis 14 as shown and measured as indicated in FIG. 3. In the illustrated embodiment, the angle 66 is about 20 degrees. In other embodiments, the angle 66 is between 15 degrees and 25 degrees. In yet other embodiments, the angle 66 is between 10 degrees and 30 degrees. In yet other embodiments, the angle 66 is between 5 degrees and 45 degrees.

The spindle axis 66 is also at an angle 68 relative to the battery axis 24 as shown and measured as indicated in FIG. 3. In the illustrated embodiment, the angle 68 is about 60 degrees. In other embodiments, the angle 68 is between 55 degrees and 65 degrees. In yet other embodiments, the angle 68 is between 50 degrees and 70 degrees. In yet other embodiments, the angle 68 is between about 30 degrees and 80 degrees.

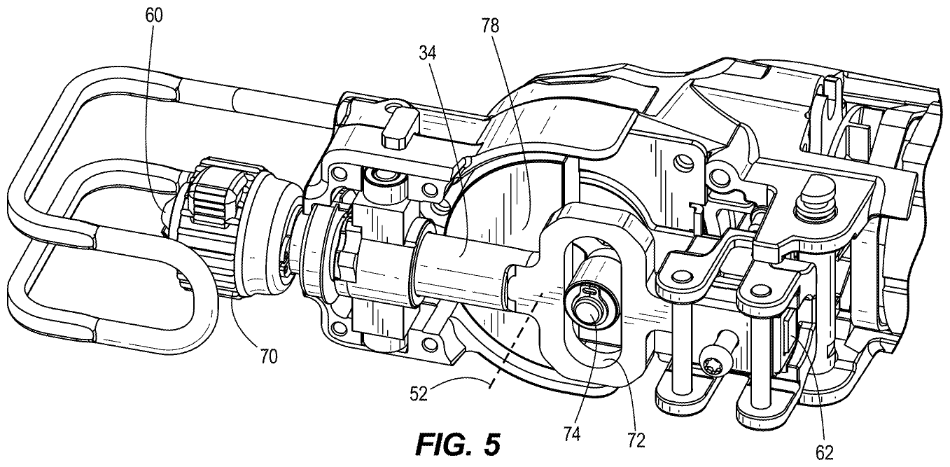

A blade clamp 70 is coupled to the spindle 34 adjacent the first end 60 of the spindle 34. The blade clamp 70 releasably couples a blade to the spindle 34 for reciprocation with the spindle 34 along the spindle axis 64 to cut a workpiece. Referring to FIG. 5, an aperture 72 is located between the first end 60 and the second end 62 of the spindle 34. The aperture 72 receives a pin 74 of the transmission 32. In the illustrated embodiment, the pin 74 is an eccentric pin offset from the drive shaft axis 52. The pin 74 is mounted to a counterweight 78, which in turn is coupled for co-rotation with the drive shaft 50. The aperture 72 and pin 74 form part of a scotch yoke mechanism. The pin 74 rotates about drive shaft axis 52 in response to rotation of the motor shaft 36. Rotation of the pin 74 about axis 52 reciprocates the spindle 34 along the spindle axis 64.

The illustrated saw 10 further includes an orbital motion assembly 82 that selectively imparts a pivoting movement to the spindle 34 during reciprocation of the spindle 34 along the spindle axis 64. The orbital motion assembly 82 includes a strike plate 86 coupled to the counterweight 78, a spindle carrier 90 pivotally coupled to the housing 28, and a cam follower or roller 94 coupled to the carrier 90 and engageable with the strike plate 86 (FIG. 3). The orbital motion assembly 82 also includes an actuator 98 movable between and engaged position and a disengaged position to selectively enable and disable the orbital motion assembly 82.

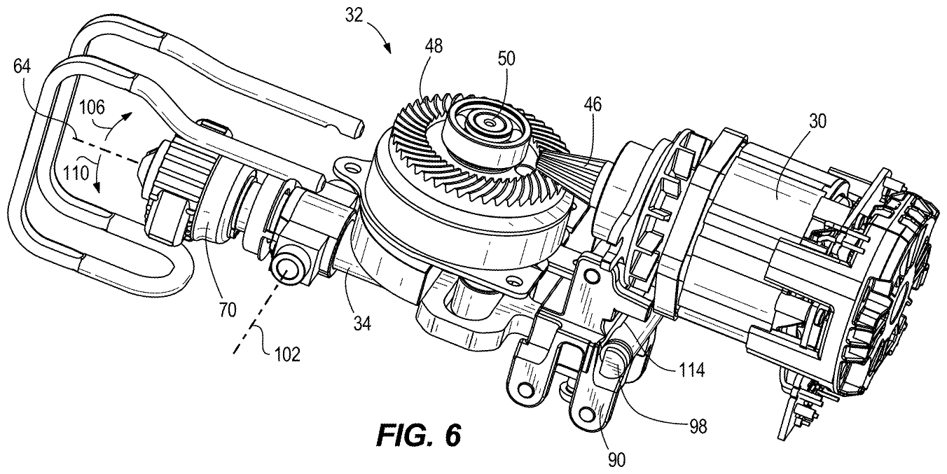

With reference to FIG. 6, the spindle carrier 90 supports the spindle 34 such that the spindle carrier 90 and the spindle 34 are pivotable together about a pivot axis 102. In the illustrated embodiment, the pivot axis 102 is perpendicular to the spindle axis 64. By pivoting about the pivot axis 102, the orientation of the spindle 34 is variable in an oscillating pattern in the directions of arrows 106 and 110 in FIG. 6. The orientation of the spindle 34 varies within a relatively narrow range in the illustrated embodiment (e.g., plus or minus about 1 degree). In other embodiments, the orientation of the spindle 34 may oscillate within a range of up to 5 degrees. In other embodiments, the orientation of the spindle 34 may oscillate within a range of up to 10 degrees.

Referring to FIG. 3, the strike plate 86 is coupled to an eccentric portion of the counterweight 78 such that the strike plate 86 reciprocates in a direction parallel to the motor axis 38 in response to rotation of the drive shaft 50 and the counterweight 78. As described below, the strike plate 86 is selectively engageable with the roller 94 to impart pivoting motion to the spindle carrier 90 and the spindle 34.

In the illustrated embodiment, the actuator 98 is shaped as a rotatable pin including a recessed or flat portion 114 (FIG. 6). A handle 120 (FIG. 2) is coupled to the actuator 98 to allow an operator of the saw 10 to rotate the actuator 98 between the engaged position and the disengaged position. When the actuator 98 is in the disengaged position (e.g., FIG. 3), the flat portion 114 is misaligned with the spindle carrier 90. The engagement between the spindle carrier 90 and the outer circumference of the actuator 98 maintains the roller 94 out of the path of the strike plate 86. Thus, when the actuator 98 is in the disengaged position, the reciprocating saw 10 is operable in a non-orbiting mode.

When the actuator 98 is moved to the engaged position, the flat portion 114 is aligned with the spindle carrier 90, allowing the rear end of the spindle carrier 90 to pivot downward (e.g., under the influence of gravity, a spring, etc.). This pivots the front end 60 of the spindle 34 upward, in the direction of arrow 106. The roller 94 moves with the spindle carrier 90 into the path of the reciprocating strike plate 86. When the strike plate 86 moves rearward (i.e. to the right in FIG. 3), the strike plate 86 engages the roller 94 and forces the roller 94 upward. This causes the rear end of the spindle carrier 90 to pivot upward, in turn pivoting the front end 60 of the spindle 34 downward, in the direction of arrow 110. Thus, when the actuator 98 is in the engaged position, the reciprocating saw is operable in an orbiting mode in which the spindle 34 oscillates about the pivot axis 102.

The relative orientations of the handle axis 14, the battery axis 24, the motor axis 38, and the spindle axis 64, including the relative angles between these axes (e.g., angles 26, 40, 42, 66, and 68) has been found to be particularly desirable for a reciprocating saw. Among other things, the saw 10 is well balanced and also the orientations provide a saw that is easy and comfortable to use. For example, a user can grasp the handle 12, actuate the trigger 20, and support and guide the saw 10 with a single hand. The battery axis 24 positions the battery 11 so that it can be easily removed and attached to the battery recess 22 while the user holds the handle 12. Also, the battery 11 and the motor 30 are two of the heaviest components of the saw 10. The battery 11 and motor 30 being on opposite ends of the handle 12 provide the user with a relatively well balanced saw, further facilitating one-handed operation. The motor axis 38 orientation (e.g., parallel to spindle axis 64) provides for a relatively compact saw 10.

Various features of the invention are set forth in the following claims

What is claimed is:

1. A reciprocating saw comprising:
a housing including a handle defining a handle axis extending centrally through the handle from a first end to a second end of the handle;
a battery receptacle located adjacent the second end of the handle;
a battery insertable into and removable from the battery receptacle along a battery axis;
a motor powered by the battery and including a motor shaft rotatable about a motor axis; and
a spindle configured to reciprocate along a spindle axis in response to rotation of the motor shaft,
wherein the spindle axis is parallel to the motor axis.

2. The reciprocating saw of claim 1, wherein the battery axis is oriented relative to the handle axis at an angle between 75 and 95 degrees.

3. The reciprocating saw of claim 2, wherein the battery axis is perpendicular to the handle axis.

4. The reciprocating saw of claim 1, wherein the motor is located adjacent the first end of the handle.

5. The reciprocating saw of claim 1, further comprising:
a drive gear coupled to the motor shaft for rotation about the motor axis;
a driven gear meshed with the drive gear; and
a drive shaft coupled for co-rotation with the driven gear about a drive shaft axis,
wherein the drive shaft axis is perpendicular to the motor axis.

6. The reciprocating saw of claim 5, further comprising an orbital motion assembly configured to selectively impart a pivoting motion to the spindle in response to rotation of the drive shaft.

7. The reciprocating saw of claim 6, wherein the orbital motion assembly includes
an actuator movable between an engaged position and a disengaged position,
a spindle carrier pivotally coupled to the housing and supporting the spindle such that the spindle carrier and the spindle are pivotable together relative to the housing about a pivot axis,
a strike plate coupled to the drive shaft, the strike plate configured to reciprocate in response to rotation of the drive shaft, and
a roller coupled to the spindle carrier,
wherein the strike plate is engageable with the roller as the strike plate reciprocates to cause the spindle carrier and the spindle to pivot back and forth about the pivot axis when the actuator is in the engaged position, and
wherein the roller is prevented from engaging the strike plate when the actuator is in the disengaged position.

8. The reciprocating saw of claim 1, wherein the motor axis is oriented relative to the handle axis at an angle between 5 and 45 degrees.

9. A reciprocating saw comprising:
a housing including a handle defining a handle axis extending centrally through the handle from a first end to a second end of the handle;
a battery receptacle located adjacent the second end of the handle;
a battery insertable into and removable from the battery receptacle along a battery axis;
a motor powered by the battery and including a motor shaft rotatable about a motor axis; and
a spindle configured to reciprocate along a spindle axis in response to rotation of the motor shaft,
wherein the handle axis is perpendicular to the battery axis, and
wherein the motor axis is oriented relative to the handle axis at an angle between 5 and 45 degrees.

10. The reciprocating saw of claim 9, wherein the spindle axis is oriented relative to the handle axis at an angle between 5 and 45 degrees.

11. The reciprocating saw of claim 10, wherein the spindle axis is parallel to the motor axis.

12. The reciprocating saw of claim 9, further comprising an orbital motion assembly configured to selectively impart a pivoting motion to the spindle,
wherein the orbital motion assembly includes
a spindle carrier pivotally coupled to the housing and supporting the spindle such that the spindle carrier and the spindle are pivotable together relative to the housing about a pivot axis,
a strike plate configured to reciprocate in a direction parallel to the motor axis, and
a roller coupled to the spindle carrier,
wherein the strike plate is engageable with the roller as the strike plate reciprocates to cause the spindle carrier and the spindle to pivot back and forth about the pivot axis when the reciprocating saw is operated in an orbiting mode, and
wherein the roller is prevented from engaging the strike plate when the reciprocating saw is operated in a non-orbiting mode.

13. The reciprocating saw of claim 9, wherein the motor is located adjacent the first end of the handle.

14. The reciprocating saw of claim 9, further comprising:
a drive gear coupled to the motor shaft for rotation about the motor axis;
a driven gear meshed with the drive gear;
a drive shaft coupled for co-rotation with the driven gear about a drive shaft axis; and
a scotch yoke mechanism coupling the drive shaft to the spindle,
wherein the drive shaft axis is perpendicular to the motor axis.

15. A reciprocating saw comprising:
a housing including a handle defining a handle axis extending centrally through the handle from a first end to a second end of the handle;
a battery receptacle located adjacent the second end of the handle;
a battery insertable into and removable from the battery receptacle along a battery axis;
a motor powered by the battery and including a motor shaft rotatable about a motor axis, the motor located adjacent the first end of the handle; and
a spindle configured to reciprocate along a spindle axis in response to rotation of the motor shaft,
wherein the spindle axis is oriented relative to the handle axis at an angle between 5 and 45 degrees.

16. The reciprocating saw of claim 15, further comprising an orbital motion assembly including an actuator movable between an engaged position and a disengaged position, wherein the orbital motion assembly is configured to impart a pivoting motion to the spindle when the actuator is in the engaged position.

17. The reciprocating saw of claim 15, Wherein the motor axis is parallel to the spindle axis.

18. The reciprocating saw of claim 17, wherein the battery axis is oriented relative to the handle axis at an angle between 75 and 95 degrees.

19. The reciprocating saw of claim 18, further comprising:
a drive gear coupled to the motor shaft for rotation about the motor axis;
a driven gear meshed with the drive gear; and
a drive shaft coupled for co-rotation with the driven gear about a drive shaft axis,
wherein the drive shaft axis is perpendicular to the motor axis.

20. The reciprocating saw of claim 15, further comprising a trigger positioned on the handle adjacent the first end.
